(19) United States
(12) Patent Application Publication
(10) Pub. No.: US 2013/0113166 A1
(43) Pub. Date: May 9, 2013

(54) Sealing module for sealing around an elongated conduit

(71) Applicant: Joakim Hjerpe, Mora (SE)

(72) Inventor: Joakim Hjerpe, Mora (SE)

(21) Appl. No.: 13/810,006

(22) PCT Filed: Jun. 13, 2011
(86) PCT No.: PCT/SE2011/050721

§ 371 Date: Jan. 14, 2013

(30) Foreign Application Priority Data
Jul. 14, 2010 (SE) 1050790.3

(51) Int. Cl. F16L 5/02; H02G 3/22

(52) U.S. Cl. CPC F16L 5/02; H02G 3/22
USPC 277/606

(57) ABSTRACT

A sealing module comprising two module halves (11) which are intended to be pressed against each other in order to sealingly surround a conduit, the respective module half comprising;—an outer base part (20) with an elongated recess (21) which is arched in cross-section; and—several mutually superposed inserts (30, 30′) received in the recess (21) of the base part, which inserts have mutually different radii and are detachably arranged in each other so that the module half (11) can be adapted to conduits with different outer diameters by adjustment of the number of inserts. The base part and the inserts are made of elastic and compressible material. Furthermore, the inserts and the internal surface of the recess of the base part are undulated with wave crests (34) and wave troughs (35) extending in the direction of curvature of the inserts and said internal surface.

### FIELD OF THE INVENTION AND PRIOR ART

The present invention relates to a sealing module according to the preamble of claim 1 for sealing around an elongated conduit, such as a pipe, a cable or a hose, at a lead-through in a wall or other structural element.

The sealing module according to the invention is of the type previously known for instance from EP 0 429 916 B1, where the diameter of a hole extending through the sealing module, which hole is intended to receive a conduit, can be adapted to the outer diameter of the conduit in question by a suitable adjustment of the number of inserts in the module halves which together form the sealing module.

### OBJECT OF THE INVENTION

The object of the present invention is to achieve a new sealing module for sealing around an elongated conduit at a lead-through in a wall or other structural element with a design and function which in at least some aspect offers an advantage as compared to previously known sealing modules of the type here in question.

### SUMMARY OF THE INVENTION

According to the present invention, said object is achieved by means of a sealing module having the features defined in claim 1.

The sealing module according to the invention comprises two module halves, which are intended to be pressed against each other in order to sealingly surround a conduit and each of which comprises:
an outer base part with an elongated recess, which is arched in cross-section and extends right across the side of the base part that is intended to face the other module half; and
several mutually superposed inserts received in the recess of the base part, which inserts have mutually different radii and are detachably arranged in each other so that the module half can be adapted to conduits with different outer diameters by adjustment of the number of inserts, wherein the undermost insert located closest to the base part has an outer side with a shape corresponding to the shape of the internal surface of the recess of the base part and an opposite inner side with a shape corresponding to the shape of the outer side of the insert located closest above this undermost insert, and wherein each one of the other inserts has an outer side with a shape corresponding to the shape of the inner side of the insert located closest beneath the insert in question.

The base part and the inserts are made of elastic and compressible material. Furthermore, the inserts and the internal surface of the recess of the base part are undulated with wave crests and wave troughs extending in the direction of curvature of the inserts and said internal surface.

The sealing module can in a simple manner, by a suitable adjustment of the number of inserts in the module halves, be adapted on the occasion for the installation to the outer diameter of the conduit around which the sealing module is intended to be applied. A sealing compression of the module halves around the conduit is facilitated by the undulation of the inserts. Owing to the undulation, the two module halves abut against the conduit through the wave crests of the inserts located closest to the conduit, which will give a reduced contact surface between the module halves and the conduit as compared to conventional module halves with smooth inserts. Owing to this reduced contact surface, the area of the inserts that has to be compressed when the module halves are squeezed around the conduit is reduced, which in its turn reduces the compressive force required for achieving this squeezing. The wave troughs and wave crests will also give the wave crests space for expansion in the axial direction of the inserts, and this will also make it easier to achieve the required compression of the inserts when the module halves are squeezed around the conduit.

According to an embodiment of the invention, the inserts and the internal surface of the recess of the base part are provided with mutually co-operating protrusions and recesses, which are in engagement with each other and which are configured to prevent a mutual rotary motion between adjacent inserts and between the undermost insert and the base part. The inserts are hereby kept in place in relation to each other and in relation to the base part, which will facilitate the handling of the module halves.

According to another embodiment of the invention, the respective insert constitutes a tube half, the inserts of the respective module half being stackable in each other. The undulation of the respective insert contributes to the possibility to design the insert as a tube half with a certain degree of shape stability even with a comparatively small wall thickness of the insert. With such somewhat shape-stable inserts, it will not only be possible to remove individual inserts from the respective base part in a conventional manner in order to increase the radius of the elongated seat in which the conduit to be sealed is intended to be received, but it will also be possible in a simple manner to insert an individual insert into the inserts already received in the base part in order to reduce the radius of this elongated seat when so needed.

Another embodiment of the invention is characterized in:
that the base part of the respective module half is provided with abutment surfaces on either side of the arched recess of the base part on the side of the base part that is intended to face the base part of the other module half, these abutment surfaces of the base part of one module half having a shape corresponding to the shape of the corresponding abutment surfaces of the base part of the other module half;
that said abutment surfaces of the respective base part are undulated with wave crests and wave troughs extending perpendicularly to the longitudinal axis of the arched recess of the base part; and
that the axially extending edges of the inserts of the respective module half are provided with edge surfaces which are undulated in correspondence with the undulation of the abutments surfaces of the base part so as to form a united undulated surface together with these undulated abutment surfaces of the base part.

A correct positioning of the module halves in relation to each other is facilitated by the undulation of said abutment surfaces and edge surfaces.

Other favourable features of the sealing module according to the invention will appear from the dependent claims and the description following below.

### BRIEF DESCRIPTION OF THE DRAWINGS

The invention will in the following be more closely described by means of embodiment examples, with reference to the appended drawings. It is shown in:

FIGS. 1a-1b two different installation steps for the installation of a sealing module according to a first embodiment of the present invention around an elongated conduit,

FIG. 2 a perspective view from a first side of the sealing module of FIGS. 1a and 1b installed in a holding device,

FIG. 3 a perspective view from a second side of the sealing module and the holding device of FIG. 2,

FIG. 4 a perspective view of a module half included in the sealing module of FIGS. 1a and 1b,

FIG. 5 a perspective view of a base part included in the module half illustrated in FIG. 4,

FIG. 6 a perspective view from above of the undermost insert of the module half illustrated in FIG. 4,

FIG. 7 a perspective view from below of the insert of FIG. 6,

FIG. 8 a perspective view from above of the uppermost insert of the module half illustrated in FIG. 4,

FIG. 9 a perspective view from below of the insert of FIG. 8, and

FIG. 10 a perspective view of a module half included in a sealing module according to a second embodiment of the invention.

### DETAILED DESCRIPTION OF PREFERRED EMBODIMENTS

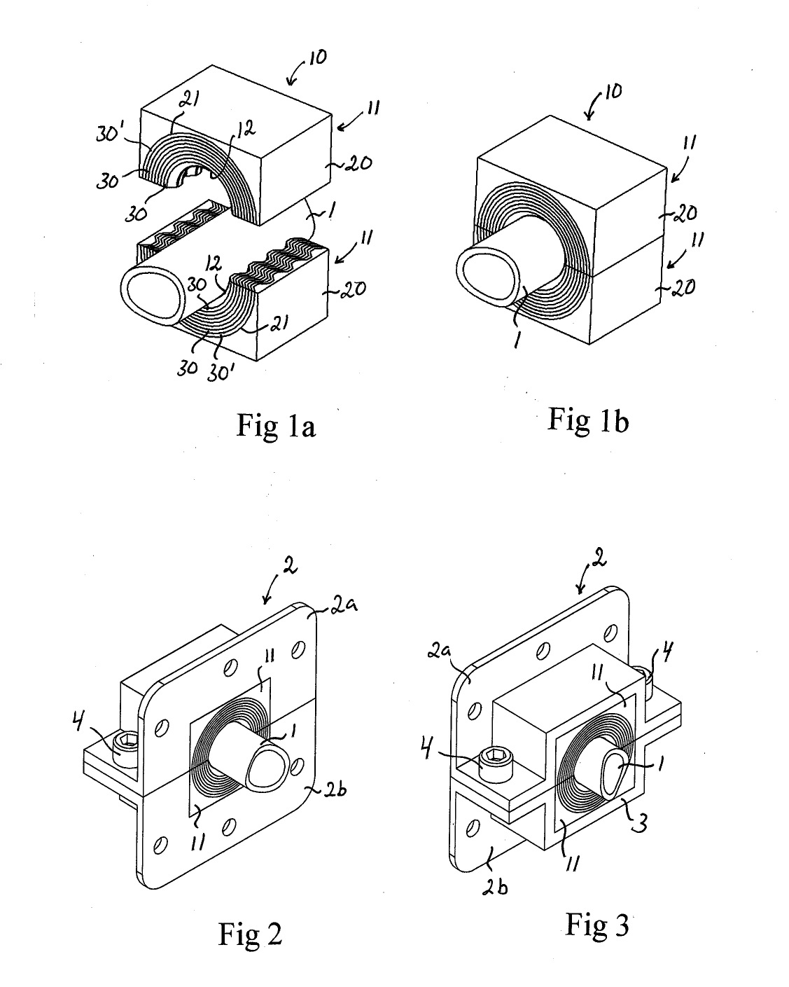

FIGS. 1a and 1b illustrate a sealing module 10 according to an embodiment of the present invention for sealing around an elongated conduit 1, such as a pipe, a cable or a hose, at a lead-through in a wall or other structural element. In a conventional manner, the sealing module 10 comprises two module halves 11, each of which being provided with an elongated recess 12 for receiving the conduit 1 to be sealed, the recess being arched in cross-section. These seats 12 are arranged to jointly form a hole that extends through the sealing module 10, when the two module halves 11 are applied against each other with the seats 12 extending opposite each other. The module halves 11 are intended to be applied against each other with said seats 12 facing each other in order to surround the conduit 1 to be sealed, as illustrated in FIGS. 1a and 1b. The sealing module 10 is thereafter fitted into a holding device 2 (see FIGS. 2 and 3), which forms a frame 3 around the sealing module. A radially directed compressive force is exerted on the sealing module 10 via this holding device 2 so that the module halves 11 are pressed against each other and against the envelop surface of the conduit 1 extending through the hole in the sealing module, and the module halves 11 are thereby brought into a sealing abutment against each other and into a sealing abutment against the envelop surface of the conduit. In the example illustrated in FIGS. 2 and 3, the holding device 2 comprises two parts 2a, 2b, which are arranged opposite each other and which are kept together and pressed against each other by means of screw members 4. In the illustrated example, the sealing module 10 is fitted into its own holding device 2. However, two or more sealing modules 10 may as an alternative be fitted side by side within the frame of a common holding device.

The respective module half 11 of the sealing module 10 comprises:
an outer base part 20 with an elongated recess 21 (see FIG. 5), which is arched in cross-section and extends right across the side 22 of the base part that is intended to face the other module half; and
several mutually superposed inserts 30, 30′ received in the recess 21 of the base part, which inserts have mutually different radii and are detachably arranged in each other so that the module half 11 can be adapted to conduits with different outer diameters by adjustment of the number of inserts 30. 30′.

The uppermost insert 30 of the respective module half 11 forms the above-mentioned seat 12 of the module half.

The base part 20 and the inserts 30, 30′ are made of elastic and compressible material. This elastic material may be a plastic material or rubber material and is suitably a thermoelastic material. The respective insert 30, 30′ preferably has a wall thickness of 0.5-2 mm.

The undermost insert 30′ located closest to the base part 20 is shown in FIGS. 6 and 7. This insert 30′ has an outer side 31 with a shape corresponding to the shape of the internal surface 23 of the recess 21 of the base part and an opposite inner side 32 with a shape corresponding to the shape of the outer side of the insert 30 located closest above this undermost insert 30′. Each one of the other inserts 30 has an outer side 31 with a shape corresponding to the shape of the inner side 32 of the insert located closest beneath the insert in question, and an inner side 32 with a shape corresponding to the shape of the outer side 31 of the insert located closest above the insert in question. The undermost insert 30′ bears against the internal surface 23 of the recess 21 of the base part all over or at least essentially all over its outer side 31, and each one of the other inserts 30 bears all over or at least essentially all over its outer side 31 against the insert located closest underneath.

According to the invention, the inserts 30, 30′ and the internal surface 23 of the recess 21 of the base part are undulated with wave crests 24, 34 and wave troughs 25, 35 extending in the direction of curvature of the inserts 30, 30′ and said internal surface 23, i.e. in the circumferential direction of a conduit 1 received in the sealing module 10. In the illustrated embodiments, the respective wave crest 24, 34 has a plane top surface 26, 36 as seen in a cross-section through the wave crest, i.e. as seen in a longitudinal section through the base part 20 and the respective insert 30, 30′, whereas the respective wave trough 25, 35 has a plane bottom surface 27, 37 as seen in a cross-section through the wave trough. An inclined side surface 28, 38 extends between the plane bottom surface 27, 37 of a wave trough and the plane top surface 26, 36 of an adjacent wave crest. The undulation of the inserts 30, 30′ and the internal surface 23 of the recess 21 of the base part could alternatively have another configuration than the one illustrated in the appended drawings.

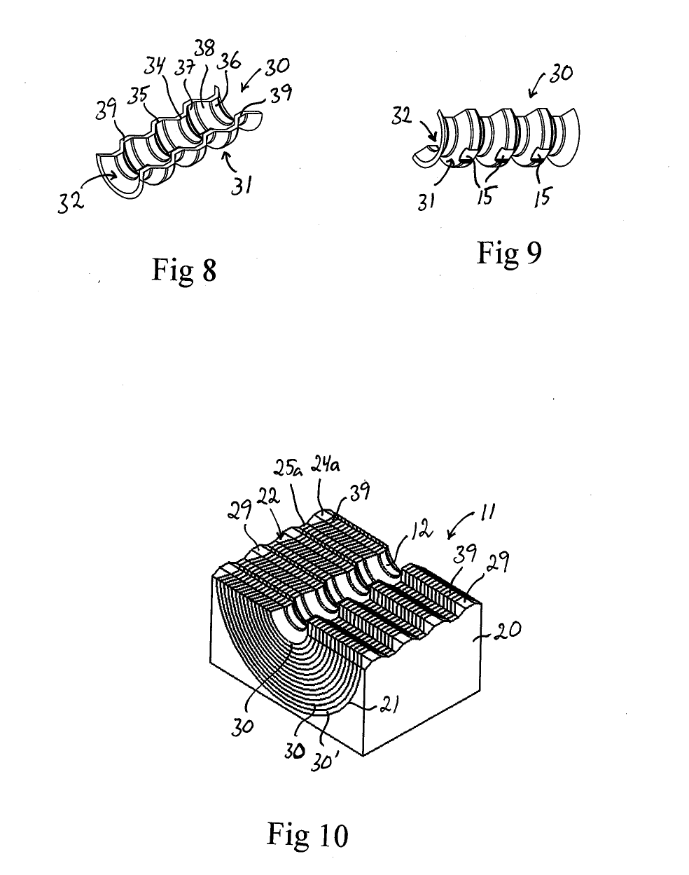

The respective insert 30, 30′ constitutes a tube half and has a certain degree of shape stability, as illustrated in FIGS. 6-9. The inserts 30, 30′ of the respective module half 11 are stackable in each other and the number of inserts of a module half can be adjusted in dependence of the diameter of the conduit 1 to be sealed by removing one or more inserts from the inserts 30, 30′ which are stacked in each other in the recess 21 of the base part, so as to thereby increase the radius of the elongated seat 12 that is intended to receive the conduit 1 to be sealed, or by inserting one or more inserts into the inserts 30, 30′ already received in the recess 21 of the base part, so as to thereby reduce the radius of said seat 12.

The inserts 30, 30′ and the internal surface 23 of the recess 21 of the base part are provided with mutually co-operating protrusions 14 and recesses 15, which are in engagement with each other and configured to prevent a mutual rotary motion between adjacent inserts 30, 30′ and between the undermost insert 30′ and the base part 20. In the illustrated embodiments, the undermost insert 30′ is on its outer side 31 provided with recesses 15 which are configured for engagement with corresponding protrusions 14 on the internal surface 23 of the recess 21 of the base part in order to prevent a mutual rotary motion between the undermost insert 30′ and the base part 20, whereas each one of the other inserts 30 on its outer side 31 is provided with recesses 15 which are configured for engagement with corresponding protrusions 14 on the inner side 32 of the insert located closest beneath in order to prevent a mutual rotary motion between adjacent inserts. As an alternative, the protrusions in question could be arranged on the outer side of the inserts 30, 30′ for engagement with corresponding recesses arranged on the internal surface of the recess 21 of the base part and on the inner side of the inserts.

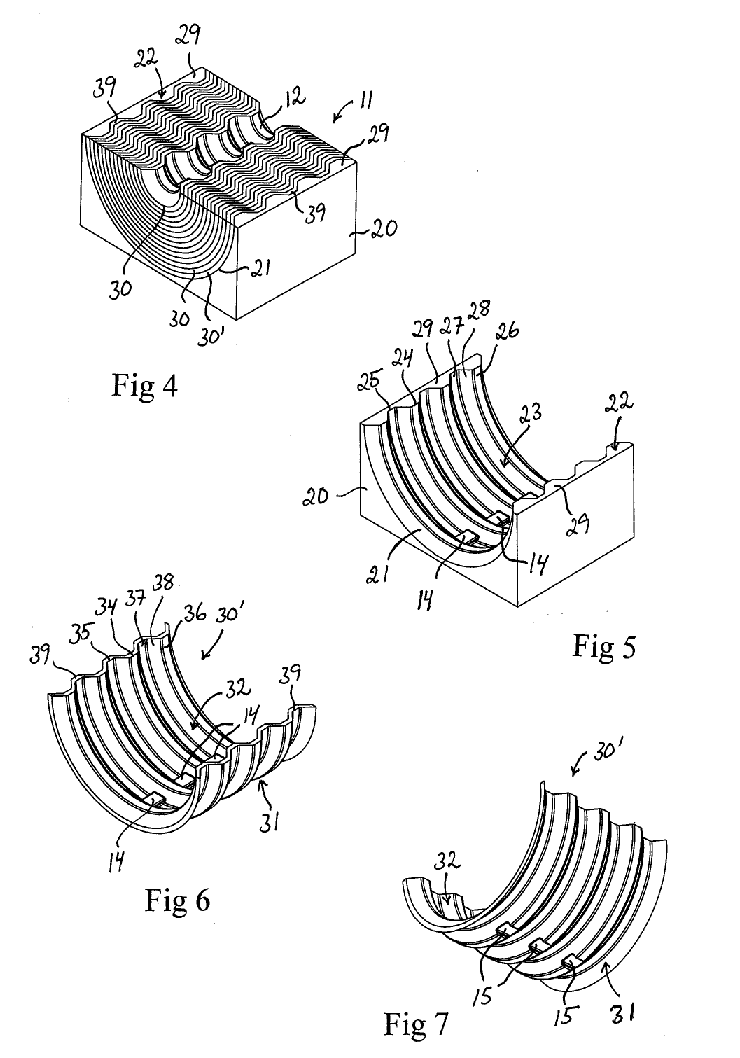

The base part 20 of the respective module half 11 is provided with abutment surfaces 29 on either side of the arched recess 21 of the base part on the side 22 of the base part that is intended to face the base part of the other module half. These abutment surfaces 29 of the base part 20 of one module half have a shape corresponding to the shape of the corresponding abutment surfaces of the base part of the other module half. In the embodiments illustrated in FIGS. 1-9, these abutment surfaces 29 are plane, and the axially extending edges of the inserts 30, 30′ are provided with plane edge surfaces 39 in order to form a united plane surface together with the plane abutment surfaces 29 of the associated base part 20. In the embodiment illustrated in FIG. 10, said abutment surfaces 29 of the base parts 20 are undulated with wave crests 24a and wave troughs 25a extending perpendicularly to the longitudinal axis of the arched recess 21 of the base part, and the axially extending edges of the inserts 30, 30′ of the respective module half 11 are provided with edge surfaces 39 which are undulated in correspondence with the undulation of the abutment surfaces 29 of the base part in order to form a united undulated surface together with these undulated abutment surfaces 29 of the base part.

Sealing modules according to the present invention may have widely different dimensions and may in a smaller variant be dimensioned to seal thin conduits for instance in the form of electric cables and may in a larger variant be dimensioned to seal wider conduits for instance in the form of sewage pipes.

In the embodiments illustrated in FIGS. 1-5 and 10 and described above, the base part 20 of the respective module half 11 is provided with only one recess 21 for receiving mutually superposed inserts 30, 30′. In this case, an individual sealing module 10 is consequently configured to achieve sealing around one single elongated conduit 1. However, the sealing module according to the invention could alternatively be configured to achieve sealing around two or more elongated conduits. In the last-mentioned case, the base part 20 of the respective module half comprises two or more mutually parallel recesses 21 of the type described above, each of which being configured to receive mutually superposed inserts 30, 30′ of the type described above in order to form two or more mutually parallel seats 12 for receiving elongated conduits.

FIGS. 1a and 1b show how a sealing module 10 of the type according to the invention can be fitted into a holding device 2, through which a radially directed compressive force is exerted on the sealing module 10. However, a sealing module 10 of the type according to the invention could alternatively be used without such a surrounding holding device 2 and instead be installed with its envelope surface in direct contact with the internal wall of a hole in a wall or other structural element. In the last-mentioned case, an axially directed compressive force is applied on the sealing module 10 through its ends so that the sealing module is compressed in the axial direction and thereby is made to expand in the radial direction outwards into a sealing contact with the wall of the hole on the outer side of the sealing module 10 and in the radial direction inwards into a sealing contact with the elongated conduit 1 that is received between the two module halves 11 of the sealing module 10. In this case, it is of course required that the sealing module 10 is designed with an outer cross-sectional shape corresponding to the cross-sectional shape of the hole into which the sealing module is to be installed. For installation in a hole with for instance round cross-sectional shape, the base part 20 of the respective module half 11 is in this case consequently to have an envelop surface with a semi-circular cross-sectional shape. In order to facilitate the axial compression and the radial expansion, the base part of the respective module half may in this case with advantage also be undulated externally on its envelop surface with wave crests and wave troughs extended in the circumferential direction of the envelop surface.

The invention is of course not in any way limited to the embodiments described above. On the contrary, several possibilities to modifications thereof should be apparent to a person with ordinary skill in the art without thereby deviating from the basic idea of the invention as defined in the appended claims.

1. A sealing module for sealing around an elongated conduit, such as a pipe, a cable or a hose, at a lead-through in a wall or other structural element, which sealing module (10) comprises two module halves (11) which are intended to be pressed against each other in order to sealingly surround a conduit, the respective module half (11) comprising:
an outer base part (20) with an elongated recess (21), which is arched in cross-section and extends right across the side (22) of the base part that is intended to face the other module half; and
several mutually superposed inserts (30, 30′) received in the recess (21) of the base part, which inserts have mutually different radii and are detachably arranged in each other so that the module half (11) can be adapted to conduits with different outer diameters by adjustment of the number of inserts (30, 30′), wherein the undermost insert (30′) located closest to the base part (20) has an outer side (31) with a shape corresponding to the shape of the internal surface (23) of the recess (21) of the base part and an opposite inner side (32) with a shape corresponding to the shape of the outer side of the insert located closest above this undermost insert, and wherein each one of the other inserts (30) has an outer side (31) with a shape corresponding to the shape of the inner side (32) of the insert located closest beneath the insert in question, wherein the base part (20) and the inserts (30, 30′) are made of elastic and compressible material; and
that the inserts (30, 30′) and the internal surface (23) of the recess (21) of the base part are undulated with wave crests (24, 34) and wave troughs (25, 35) extending in the direction of curvature of the inserts and said internal surface.

2. A sealing module according to claim 1, wherein the undermost insert (30′) bears against the internal surface (23) of the recess (21) of the base part all over or at least essentially all over its outer side (31), and each one of the other inserts (30) bears all over or at least essentially all over its outer side (31) against the insert located closest beneath.

3. A sealing module according to claim 1, wherein the inserts (30, 30′) and the internal surface (23) of the recess (21) of the base part are provided with mutually co-operating protrusions (14) and recesses (15), which are in engagement with each other and which are configured to prevent a mutual rotary motion between adjacent inserts (30, 30′) and between the undermost insert (30′) and the base part (20).

4. A sealing module according to claim 3, wherein
the undermost insert on its outer side (31) is provided with one or more recesses (15) configured for engagement with corresponding protrusions (14) on the internal surface (23) of the recess (21) of the base part in order to prevent a mutual rotary motion between the undermost insert (30′) and the base part (20); and
each one of the other inserts (30) on its outer side (31) is provided with one or more recesses (14) configured for engagement with corresponding protrusions on the inner side (32) of the insert located closest beneath in order to prevent a mutual rotary motion between adjacent inserts.

5. A sealing module according to claim 3, wherein
the undermost insert on its outer side (31) is provided with one or more protrusions configured for engagement with corresponding recesses on the internal surface (23) of the recess (21) of the base part in order to prevent a mutual rotary motion between the undermost insert (30′) and the base part (20); and
each one of the other inserts (30) on its outer side (31) is provided with one or more protrusions configured for engagement with corresponding recesses on the inner side (32) of the insert located closest beneath in order to prevent a mutual rotary motion between adjacent inserts.

6. A sealing module according to claim 1, wherein the respective insert (30, 30′) is made of thermoelastic material.

7. A sealing module according to claim 1, wherein the respective insert (30, 30′) has a wall thickness of 0.5-2 mm.

8. A sealing module according to claim 1, wherein the base part (20) is made of thermoelastic material.

9. A sealing module according to claim 1, wherein the respective insert (30, 30′) constitutes a tube half, the inserts (30, 30′) of the respective module half (11) being stackable in each other.

10. A sealing module according to claim 1, wherein
the base part (20) of the respective module half (11) is provided with abutment surfaces (29) on either side of the arched recess (21) of the base part on the side of the base part that is intended to face the base part of the other module half, these abutment surfaces (29) of the base part (20) of one module half having a shape corresponding to the shape of the corresponding abutment surfaces (29) of the base part (20) of the other module half;
said abutment surfaces (29) of the respective base part (20) are undulated with wave crests (24a) and wave troughs (25a) extending perpendicularly to the longitudinal axis of the arched recess (21) of the base part; and
the axially extending edges of the inserts (30, 30′) of the respective module half (11) are provided with edge surfaces (39) which are undulated in correspondence with the undulation of the abutments surfaces (29) of the base part so as to form a united undulated surface together with these undulated abutment surfaces (29) of the base part.

11. A sealing module according to claim 2, wherein the inserts (30, 30′) and the internal surface (23) of the recess (21) of the base part are provided with mutually co-operating protrusions (14) and recesses (15), which are in engagement with each other and which are configured to prevent a mutual rotary motion between adjacent inserts (30, 30′) and between the undermost insert (30′) and the base part (20).

12. A sealing module according to claim 11, wherein
the undermost insert on its outer side (31) is provided with one or more recesses (15) configured for engagement with corresponding protrusions (14) on the internal surface (23) of the recess (21) of the base part in order to prevent a mutual rotary motion between the undermost insert (30′) and the base part (20); and
each one of the other inserts (30) on its outer side (31) is provided with one or more recesses (14) configured for engagement with corresponding protrusions on the inner side (32) of the insert located closest beneath in order to prevent a mutual rotary motion between adjacent inserts.

13. A sealing module according to claim 11, wherein
the undermost insert on its outer side (31) is provided with one or more protrusions configured for engagement with corresponding recesses on the internal surface (23) of the recess (21) of the base part in order to prevent a mutual rotary motion between the undermost insert (30′) and the base part (20); and
each one of the other inserts (30) on its outer side (31) is provided with one or more protrusions configured for engagement with corresponding recesses on the inner side (32) of the insert located closest beneath in order to prevent a mutual rotary motion between adjacent inserts.

14. A sealing module according to claim 13, wherein the respective insert (30, 30′) is made of thermoelastic material.

15. A sealing module according to claim 12, wherein the respective insert (30, 30′) is made of thermoelastic material.

16. A sealing module according to claim 11, wherein the respective insert (30, 30′) is made of thermoelastic material.

17. A sealing module according to claim 5, wherein the respective insert (30, 30′) is made of thermoelastic material.

18. A sealing module according to claim 4, wherein the respective insert (30, 30′) is made of thermoelastic material.

19. A sealing module according to claim 3, wherein the respective insert (30, 30′) is made of thermoelastic material.

20. A sealing module according to claim 2, wherein the respective insert (30, 30′) is made of thermoelastic material.
